(19) United States
(12) Patent Application Publication
(10) Pub. No.: US 2009/0306254 A1
(43) Pub. Date: Dec. 10, 2009

(54) Thickening System and Method

(75) Inventors: Maarten van der Wielen, Nuenen (NL); Phil Winston, San Diego, CA (US); John Swazey, San Diego, CA (US); Ross Clark, San Diego, CA (US); Maarit Lahtinen, Aanekoski (FI)

Correspondence Address: Peter G. Pappas;Sutherland Asbill & Brennan LLP, 999 Peachtree Street, NE, Atlanta, GA, 30309, US

(73) Assignee: CP KELCO U.S., INC., Atlanta, GA (US)

(21) Appl. No.: 12/542,288

(22) Filed: Aug. 17, 2009

Related U.S. Application Data
(63) Continuation of application No. 11/717,418, filed on Mar. 13, 2007.

(51) Int. Cl. C08L 1/28; C08L 1/08

(52) U.S. Cl. 524/44; 524/35

(57) ABSTRACT

Paint formulations that exhibit improved performance characteristics due to the presence of a combination of a cellulose ether (carboxymethylcellulose and/or hydroxyethylcellulose) and a network building polymer (gellan gum, carrageenan, etc., as examples) as a thickening system therein are provided. Such a combination permits long-term shelf stability of the paint formulation while simultaneously according effective flow, leveling, and other important properties to the final paint formulation. The combination of the cellulose ether and a network building polymer allows for a lower viscosity cellulosic compound to impart the desired rheological behavior therein while also permitting the other desirable characteristics noted above. Such paint compositions also exhibit improved atomization for spray applications with such a thickening system.

### FIELD OF THE INVENTION

This invention pertains to paint formulations that exhibit improved performance characteristics due to the presence of a combination of a cellulose ether (carboxymethylcellulose and/or hydroxyethylcellulose, as examples) and network building polymer (gellan gum, carrageenan, etc., as examples) as a thickening system therein. Such a combination permits long-term shelf stability of the paint formulation while simultaneously according effective flow, leveling, and other important properties to the final paint formulation. The combination of the cellulose ether and a network building polymer allows for a lower viscosity cellulosic compound to impart the desired rheological behavior therein while also permitting the other desirable characteristics noted above. Such paint compositions also exhibit improved atomization for spray applications with such a thickening system.

### BACKGROUND OF THE INVENTION

Thickeners are used in numerous products for rheological control purposes and particularly for increasing viscosity and imparting thixotropic properties to the products. Thickeners for water-dispersed compositions require compatibility and stability, especially in latex paints. Paints are surface coatings applied to substrates and dried to form continuous films for decorative purposes as well as to protect the substrate. Consumer paints are air-drying and primarily decorative architectural coatings applied to interior or exterior surfaces, where the coatings are sufficiently fluid to flow and form a continuous paint film and subsequently dry at ambient temperatures. Industrial maintenance coatings are similar coatings applied to substrates in industrial environments to primarily protect the substrate. Spray paints are applied with the use of an atomizing aperture and a propellant to apply with force, rather than by brushing.

A paint ordinarily comprises an organic polymeric binder, pigments, and various paint additives. In dried paint films, the polymeric binder functions as a binder for the pigments and provides adhesion of the dried paint film to the substrate. The pigments may be organic or inorganic and functionally contribute to opacity and color in addition to durability and hardness of the dried paint film, although some paints contain little or no opacifying pigments and can be described as clear or opaque coatings. The manufacture of paints involves addition of paint additives (for example biocides, pH controllers, surface control agents, foam control agents, pigments dispersants, wetting agents), addition of pigments and grinding of pigments, addition of thickeners for rheology control and addition of polymeric binder.

Latex paints require effectiveness in a number of properties to permit proper utilization thereof. For instance, a paint should exhibit a suitable flow out of the storage receptacle as well as adhesion to a brush. Upon application to a surface, the paint should flow and level within the brush stroke or paint roller tracks left on the surface so as to create a uniform coating without streaks therein. Furthermore, a latex paint should exhibit quick drying times to prevent any gravitational pull to cause any applied to a vertical surface to run down the target substrate or sag after application. Additionally, latex paints should show a uniform coloration over the target surface, both in terms of the pigments applied, as well as overall coating upon expectation of the user that if the same stroke is applied over the entire target surface, the resultant appearance will be even and level. Lastly, it is also preferable that latex paints exhibit a propensity for stability when stored after initial mixing of a desired color on-site or at a place of purchase. Thus, phase separation is highly undesirable of the subject latex paint as, alluded to above, non-uniformity in final applied colorations would most likely result if a phase separation has occurred without significant mixing.

As noted above, due to the continuous aqueous phase in latex polymers, latex paints must contain dispersants and thickeners to promote adequate suspension of the pigment along with proper application rheology and flow. The paint viscosity during storage must be adequately high to prevent settling, but readily reduced by applied shear to spread and flow evenly. Latex paint typically exhibits thixotropic rheology to enable the paint to be applied readily by brush or roller or spray application. On a vertical wall, thixotropy will enable the applied paint to flow into a smooth continuous paint film without sagging.

For many years, the thickeners of choice for latex paints were derivatives of cellulose, including carboxymethyl cellulose (CMC), hydroxyethyl cellulose (HEC), ethyl hydroxyethyl cellulose (EHEC), methyl cellulose (MC), methyl hydroxylethyl cellulose (MHEC), hydroxypropylmethyl cellulose (HPMC) ethers alone and blends of them. These polymers thicken the water-phase of the paint and increase the viscosity of the paint overall. These polymers are especially useful at increasing the high shear rate viscosity of the paint.

However, these polymers do not generally produce high viscosity at rest or at low shear rates which relates to the suspensional capability of the paint formulation, nor do they generally provide a yield value to the paint which also is useful for suspension. In recent years, associative thickeners have been used, including hydrophobically modified hydroxyethyl cellulose and hydrophobically modified polyethylene glycols with the terminal hydrophobes attached by urethane linkages (HEUR). These systems associate with themselves and/or the binder to produce very good flow and leveling, but are not effective at suspending pigments or controlling the sag of a paint. All of these thickeners provide various levels of application properties, including roller spatter resistance and flow and leveling, but none of the aforementioned polymers are particularly good at providing in-can stability to the paint or providing sag control. Other polymers can provide these benefits but usually at the expense of other characteristics. For example, xanthan gum provides superior in-can suspension and sag control but will also affect flow and leveling of the paint and will increase cost and so its use is primarily restricted to texture coatings. Combinations of various cellulose ethers and hydrophobically modified associative thickeners have been used, but they also have disadvantages, e.g. syneresis and poor suspension properties, especially at elevated temperatures.

Thus, an improvement over the thickening systems utilized in the past, particularly with respect to suspension of pigments and sag control is highly desirable without significantly adversely affecting flow and leveling. The present invention provides the desirable rheology through an association of cellulose ether and the gel mechanism of a supplemental network building polymer (such as, as one non-limiting example, gellan gum) fluid gel.

### ADVANTAGES AND BRIEF DESCRIPTION OF THE INVENTION

One distinct advantage of the present invention is that the addition of small amounts of gellan gum with a cellulose ether effectively provides acceptable levels of performance for latex paint formulations, whereas other thickening systems provide improvements in certain categories of such characteristics, rather than an across-the-board acceptability level. Another advantage of the present invention is the ability of such a paint thickening system of small amounts of gellan gum coupled with a cellulose ether to improve the atomization in spray paint formulations thickened therewith.

In essence, it has now been determined that useful blends could be prepared for paint formulations using common thickeners and low levels of gelling polymers. For example blends of CMC, HEC, HPMC, HPC, MC, among other cellulose ethers with low concentrations of low or high acyl gellan gum, can provide the ideal rheology for many paint systems. This technology is accomplished by using low levels of a gelling polymer. The levels are chosen such that the concentration of the gelling polymer is too low to make a continuous gel or if a continuous gel does form, it is very weak and can be easily mechanically disrupted to a fluid. For low and high acyl gellan, this concentration is typically in the range of 0.03025-0.2% by total formulation weight of the total thickening system present therein the target paint formulation. In a potentially preferred embodiment, it has been determined that low acyl gellan gum fluid gels work particularly well in combination with carboxymethylcellulose (CMC). In another potentially preferred embodiment, low acyl gellan gum functions well in combination with hydroxyethylcellulose (HEC).

Accordingly, the present invention encompasses a paint formulation comprising at least one binder, at least one solvent, at least one pigment, and a thickening system comprising at least one cellulose ether and at least one network building polymer, wherein the ratio of the amount of cellulose ether to network building polymer is from 4:1 to 40:1, preferably to 20:1. Also encompassed within this invention is a paint formulation comprising at least one pigment, at least one binder, at least one solvent, and a thickening system consisting of at least one cellulose ether and at least one network building polymer, wherein said thickening system is present in an amount of from 0.1 to 5% by weight of the entire paint formulation, wherein said paint formulation exhibits a higher sag rating, a viscosity increase of at least 15%, and an equal or improved at least the same level of syneresis control after being subject to a package stability test at 25° C. for 7 weeks as that exhibited by a paint formulation comprising the same components, except for the presence of said network building polymer [wherein the viscosity increase expressed in % for the present invention is defined as: (Viscosity of the invention system at 0.3 rpm Brookfield readings−Viscosity of the reference paint at 0.3 rpm Brookfield readings)*100% divided by (Viscosity of the reference paint at 0.3 rpm Brookfield readings), in which the reference paint does not contain the network building polymer fraction and is having an equal Stormer viscosity or equal ICI viscosity as the invention system (containing the cellulosic and network building polymer) and in which the value at 0.3 rpm is recorded coming from higher shear rates as described in more detail below].

### DETAILED DESCRIPTION OF THE INVENTION

As noted above, the present invention is based upon the determination that small amounts of a gelling polymer, namely high or low acyl gellan gum, in combination with a cellulose ether thickener, provides a thickening system for paint formulations that accord excellent characteristics for many highly desired characteristics of such paints. The required combination of thickener and gum creates a reliable viscosity modification system without gelling the paint formulation to the degree that simple mixing would not be effective in de-gelling such a composition. The gellan gum component thus acts in a fluid capacity, rather than as a gelling agent, to impart retain fluidity withto the cellulose ether base thickener yet retaining many of the benefits of a gelled system, thereby contributing to the desirable properties outlined above and discussed in greater detail below.

In general, it is believed without intending to be limited to any specific scientific theory, that the inclusion of a small amount of network building polymer (i.e., gellan gum) within a paint formulation including a cellulose ether thickener imparts a smooth flow with good suspending capability simultaneously for the paint. Cellulose ethers are known to have smooth flow upon pouring, but questionable suspension capabilities alone. Network building polymers (gellan gum, carrageenan, etc.) all exhibit excellent suspension capabilities alone; however, these materials also exhibit a structured texture when poured. Thus, in a paint formulation comprising a network building polymer thickener, although the formulation may exhibit excellent suspension characteristics for the pigments and other solids components present therein, the formulation itself will not flow smoothly, or as smoothly desired for a paint. In such a situation, as one example, the paint will not be easily spread over a target area during application and will exhibit defined lines in the finished treatment due to the applying brush bristles. Likewise, with a cellulose ether thickening system alone, the paint formulation would exhibit a rather poor suspension of the solids therein, but smooth flow. Improved flow with excellent suspension properties are thus distinct advantages of the cellulose ether/network building polymer (gellan gum, etc.) thickening system as now discovered (as well as a number of other characteristics) over previous systems including cellulose ethers or network building polymers alone.

The thickening system components of the inventive formulations include cellulose ethers and network building polymers. Potentially preferred components are listed and described below in greater detail:

Carboxymethyl cellulose is prepared from cellulose (e.g. from cotton linters or wood pulp) by introducing carboxymethyl ether groups where there had been hydroxyl groups previously.

The structure of cellulose contains of glucopyranosyl units that have each three hydroxyl sites that are capable of etherification to carboxymethyl groups. Hence, if all sites were reacted the degree of substitution (DS) of CMC would be 3.0. In practice the DS is typically between 0.5 and 1.5. The molecular weight of CMC will typically range from about 30,000 to 1,000,000 Daltons. If applied as a 1% solution, the viscosity at 25° C. will show a typical viscosity of 10-50,000 mPas.

A CMC (as well as other cellulose ethers) solution can show different rheological behavior; typically a pseudoplastic behavior is obtained, but even the system can be Newtonian at low molar masses (and/or low concentrations). When heated the solution will thin, and upon cooling it will thicken. Because of the anionic nature of the CMC and the presence of hydroxyl groups different kinds of interactions (inter, intra, and with other additives) will exist. Depending on parameters like electrolyte conditions (type and level) and substitution pattern (DS and DS-distribution) the system can also show thixotropic behavior. Hydroxyethyl-cellulose (HEC) is a non-ionic cellulose ether which dissolves readily in water either cold or hot. It is used to produce solutions having wide range of viscosity, which is proportional with the molecular weight of HEC. HEC is commonly used as a thickener, protective colloid, binder, stabilizer and suspending agent in variety of industrial applications, such as water-based paints, adhesives, emulsion polymers, toothpaste, cosmetics and building products.

Cotton linters or wood pulp can be are used as raw materials and ethylene oxide for the production of HEC. HEC is manufactured by reacting ethylene oxide with the reactive hydroxyls of the anhydroglucose units that compose the cellulose chain. Three hydroxyl groups of each of the anhydroglucose units if the cellulose are activated by sodium hydroxide. Subsequently these groups are etherified with ethylene oxide to form the hydroxyethyl ether of cellose. Ethylene oxide, reacting at previously substituted hydroxyl groups, can polymerize to form a side chain. The reaction product is purified and grinded to a fine granular powder.

The molecular substitution, or MS, of the HEC is the average number of moles of ethylene oxide that becomes attached to each anhydroglucose unit in cellulose, in the two ways described above. Degree of substitution (DS) in commercially available HEC is 0.8-1.2 and MS 1.5-3. Solutions of HEC show pseudoplastic behavior and HEC solutions with very high viscosity can show some thixotropy. Most HEC products are soluble not only in water, but also in mixtures of water and water-miscible organic solvents at water contents above 40%.

Gellan gum is a heteropolysaccharide prepared by fermentation of Sphingomonas elodea, ATCC 31461. Gellan gum is available from CPKelco U.S. Inc., under various names, including KELCOGEL®, KELCOGEL AFT, and KELCOGEL LT100. Processes for preparing gellan gum include those described in U.S. Pat. Nos. 4,326,052 and 4,326,053. It is useful for a variety of gelling, texturing, stabilizing and film forming applications, particularly as a gelling agent in foods, personal care products and industrial applications.

The primary structure of gellan gum consists of a linear tetrasaccharide repeat structure. Each repeating unit comprising four (4) sugar units of 1,3-β-D-glucose; 1,4-β-D-glucuronic acid; 1,4-β-D-glucose and 1,4-α-L-rhamnose. In its native or high acyl form, two acyl substituents-acetate and glycerate—are present. The molecular weight of gellan gums can range from about 400,000 to 700,000 Daltons. These gums are supplied as free-flowing powders containing about 10 to 15% water by weight.

The deacylated gellan gum (heteropolysaccharide S-60) described in U.S. Pat. No. 4,326,053 is prepared by fermenting Sphingomonas elodea in a suitable fermentation medium under suitable conditions and thereafter, the pH is adjusted to 10 with KOH, and the temperature is maintained at 90-95° C. for 15 minutes. The pH is then lowered to 6-8 with dilute HCl or H2SO4, and the gum is recovered using typical filtration and precipitation steps. The molecular weight typically ranges from 400,000 to 600,000 Daltons.

Both forms of gellan gun can be used at low concentrations to produce “fluid gels”. Gellan gum “fluid gels” are weak gelling systems that have been subjected to shear either during or after the gelation process. The application of shear disrupts normal gelation and results in smooth, homogeneous, pourable “structured liquids”. These fluid gels are extremely efficient at suspending a variety of materials, including insoluble minerals used in paints and coatings yet can be easily sprayed. They are transparent or opaque depending on the grade of gellan and the nature of other ingredients.

The gellan concentration range within which fluid gels can be prepared is 0.025 to 0.2% by weight of water. Higher concentrations generally lead to a broken down gel that is very grainy and will not flow smoothly. Fluid gels can be prepared with either low acyl gellan gum (e.g. KELCOGEL AFT) or high acyl gellan gum (e.g. KELCOGEL LT100). In the case of low acyl gellan gum, it is necessary to add an electrolyte; if this is a divalent metal salt, the required concentration is very low (as low as 1 mM Ca2+). For example, low acyl gellan gum fluid gels provide a particularly good yield development at 5 mM Ca2+ (0.02% Ca2+). Monovalent salts require higher concentrations to obtain good yield (roughly 20× the concentration of divalent ions). For example, when using NaCl, one can obtain a good yield value at 1% NaCl (0.4% Na+). By contrast, high acyl gellan gum usually does not require additional ions beyond that contributed by a preservative or softened water to provide a significant yield value. Low acyl gellan gum is usually preferred for formulations with a pH of 8 or above because the high acyl gellan gum can de-acylate over time at alkaline pH and lead to stability issues. However, both forms of gellan gum form stable fluid gels over the range of pH 3-7 with the low acyl form being again preferred at pH ranges below 3.

In the preferred case of HEC or CMC with low acyl gellan gum, the HEC or CMC provides the high shear viscosity while the low acyl gellan gum provides high viscosity at low shear rates and a true yield point to the formulation. This high viscosity at low shear rates and the presence of a yield value provides exceptional suspension to the pigments and therefore in-can stability is improved. At appropriate levels, sag control can also be improved as the smooth texture of the formulation is effectuated favorably upon inclusion of the gellan gum component (as discussed above). The combination of low molecular weight HEC or CMC can provide adequate flow and leveling while still maintaining the desired in-can stability and sag control. In other words, blends with HEC or CMC and low acyl gellan have the advantage of not altering the cellulosic rheology at high shear rates (rates encountered during application of the paint by brush or roller) while imparting much higher viscosity at rest or at low shear rates than cellulosic alone. In addition, in the case where gellan is present, the spattering on the walls of the mixing vessel during pigment grinding was reduced significantly as compared to systems with only a cellulosic at similar Stormer viscosity.

It has been found that a combination of from 1:4 to 1:20 ratio by weight of gellan gum and either carboxymethylcellulose or hydroxyethylcellulose will impart the above-noted highly desired properties for latex paint compositions. One advantage of such a thickening combination is that the viscosity modification created with such a combination, particularly for latex paint systems, is more pronounced than either of the gellan or cellulose ethers present without the other. Another advantage of such a paint thickening combination is that improvements in many of the desirable paint characteristics are provided as a result—for example, resultant latex paint formulations including the combination exhibit improved sag control, lower spattering, and effective scrub resistance over that of the cellulosic control. Yet another advantage of this paint thickener combination is that the resultant paint will not exhibit any appreciable sedimentation or precipitation of pigment after long storage.

Accordingly, this invention encompasses a paint formulation comprising at least one pigment, at least one binder, at least one solvent, and a combination of a cellulose ether selected from the group consisting of carboxymethyl cellulose (CMC), hydroxyethyl cellulose (HEC), ethyl hydroxylethyl cellulose (EHEC), methyl cellulose (MC), methyl hydroxylethyl cellulose (M TEC), hydroxypropylmethyl cellulose (HPMC) ethers alone and mixtures thereof, and at least one network building polymer selected from the group consisting of gellan gum, iota carrageenan, kappa carrageenan or blends thereof high or low methoxy pectin or blends thereof alginate, agar, gelatin, etc. or blends thereof, wherein the cellulose ether and network building polymer are present in an amount together of from about 0.1 to about 5% by weight of the total formulation, and the ratio of both components is from 4:1 to about 40:1 (preferably to about 20:1_, respectively.

By using a small amount of a network building polymer (again, preferably, though not necessarily, gellan gum), it has been found that lower viscosity grades of cellulose ether may be used to effectuate improved flow, level, spatter, to a target painted substrate as well. This combination provides excellent viscosity build in latex paints and further helps in suspending the pigments. These and other advantages of this invention will become more apparent by referring to the detailed description and the illustrative examples.

As noted above, a specific combination of network building polymer and cellulose ether will impart highly desired properties to latex paint formulations (either brush-applied, roller-applied, or spray-on varieties).

Examples of gellan gum are KELCOGEL®, KELCOGEL AFT, KELCOGEL CG-LA, KELCOGEL CG-HA and KELCOGEL LT100 from CPKelco US, Inc. Examples of carboxymethylcellulose (CMC) are FINNFIX® and Cekol® from CPKelco Oy or CPKelco BV. Examples of hydroxyethylcellulose (HEC) are CELLOSIZE® ER4400 from Dow Chemical and NATROSOL® 250HBR from Aqualon. Examples of carrageenan are various GENUGEL® and GENUVISCO® products from CPKelco US, Inc. Examples of (other network building polymers) include pectin (available as various GENU products from CPKelco US, Inc.), sodium alginate (available from ISP under the Kelgin tradename), agar and gelatin, among many others.

In accordance with this invention, the combination is either initially formed outside the latex paint, or possibly added sequentially to the target composition (either component first), in order to impart the desired properties thereto.

Various components may be present within the paint formulation, including the latexes, pigments, and solvents, as well as coalescing agents, and other components. The level of thickener is determined by the rheological properties desired in the paint. Any solids component (pigments, etc.) is not restrictive in its form; however, powders, granules, flakes or pellets are particularly suitable.

Paints are commonly characterized in terms of their pigment volume concentration (PVC), which is the volume relationship of pigment to total solids in the dry paint film. The PVC, usually expressed as a percentage, is the total pigment volume divided by the total volume of pigment and binder in the dry film. The minimum value of the PVC for the water-borne paints of this invention is preferably about 15%. The maximum value is preferably about 85%, and most preferably about 80%. Typical levels of pigment and binder depend on the type of paint, i.e. gloss, semi-gloss and flat or matte finish.

Typical levels of pigment and binder depend on the type of paint, i.e. gloss, semi-gloss and flat or matte finish. The examples of both semi-gloss and flat should be sufficient for giving the typical levels.

Suitable pigments and fillers include those known from the prior art, as may be derived, for example, from Luckert, Pigment+Fullstoff Tabellen, 5th edition, Laatzen, 1994. As inorganic white pigments, mention should be made in particular of oxides, such as titanium dioxide, zinc oxide (ZnO, zinc white), zirconium oxide, carbonates such as lead white, sulfates, such as lead sulfate, and sulfides such as zinc sulfide, and lithopones; titanium dioxide is particularly preferred. As inorganic chromatic pigments, mention should be made of those from the group of oxides and hydroxides in the form of their individual inorganic compounds or mixed phases, especially iron oxide pigments, chromium oxide pigments and oxidic mixed-phase pigments with rutile or spinel structure, and also bismuth vanadate, cadmium, cerium sulphide, chromate, ultramarine and iron blue pigments. Examples of iron oxide pigments are Colour Index Pigment Yellow 42, Pigment Red 101, Pigment Blue 11, Pigment Brown 6, and transparent iron oxide pigments. Examples of chromium oxide pigments are Colour Index Pigment Green 17 and Pigment Green 18. Examples of oxidic mixed-phase pigments are nickel titanium yellow and chromium titanium yellow, cobalt green and cobalt blue, zinc iron brown and chromium iron brown, and also iron manganese black and spinel black.

Examples of preferred organic pigments are those of the monoazo, disazo, laked azo, beta.-naphthol, Naphiol AS, benzimidazolone, disazo condensation, azo metal complex, isoindoline and isoindolinone series, and also polycyclic pigments such as those from the phthalocyanine, quinacridone, perylene, perinone, thioindigo, anthraquinone, dioxazine, quinophthalone and diketopyrrolopyrrole series. Also suitable are laked dyes such as Ca, Mg and Al takes of dyes containing sulphonic acid or carboxylic acid groups, and also carbon blacks, which for the purposes of this specification are taken to be pigments and of which a large number are known, for example, from Colour Index, 2nd edition. Mention should be made in particular of acidic to alkaline carbon blacks obtained by the furnace black process, and also chemically surface-modified carbon blacks, examples being sulpho- or carboxyl-containing carbon blacks.

Examples of inorganic black pigments that should be mentioned include those as already described above together with the inorganic chromatic pigments, especially black iron oxide, spinel black, and black oxidic mixed-phase pigments.

Fillers particularly comprise substances other than the pigments mentioned, these substances being primarily light in color and being inert towards the binder of component b). With particular preference, the fillers have a lower optical refractive index than the aforementioned white pigments. Examples of inorganic fillers that may be mentioned include carbonates, such as chalk, calcide or dolomite, for example, silicon dioxide (ground quartz), natural or synthetic silicas, silicates, such as talc, kaolin or mica, for example, and sulfates such as heavy spar or barium sulfate, for example. Examples of organic fillers include polymeric powders and those known as hollow spheres.

As additives, the paint formulation may optionally comprise surface-active agents, defoamers and, for example, foam preventatives and water-softening auxiliaries. In accordance with the invention, there is no need to impose any restriction regarding the selection of suitable compounds for the surface-active agents. They are used preferably for physical stabilization of the finely divided pigment and filler particles during the preparation of the solids component and/or in the finished paint and coating materials themselves. Surface-active agents used are preferably dispersants, wetting agents and emulsifiers as widely used in the commercially customary paint and coating materials. In particular, they may be nonionic, ionic, cationic or amphoteric, and monomeric or polymeric, in nature. Preferred dispersants include oxalkylation products obtainable by condensing phenolic OH-containing aromatics with formaldehyde and NH-functional groups; water-soluble polyisocyanate adducts containing hydrophilic polyether chains and preferably having a maximum isocyanate group content of 1.0% by weight, containing 30-99.5% by weight of ethylene oxide units arranged within polyether chains and incorporated by way of monofunctional alcohols, and having an ionic group content of 0-200 milliequivalent/10 g polyisocyanate adduct; water-soluble inorganic salts, especially borates, carbonates, silicates, sulfates, sulfites, selenates, chlorides, fluorides, phosphates, nitrates and aluminates of the alkali metals and alkaline earth metals and of other metals, and also ammonium; polymers composed of repeating succinyl units, especially polyaspartic acid; and nonionic, anionic, cationic or amphoteric compounds (such as nonionic alkoxylates, alkylolamides, esters, amine oxides and alkyl polyglycosides, as merely examples).

Other thickeners may also be utilized in these paint formulations, such as dextrins or cyclodextrins, starch and starch derivatives, especially degraded or partially degraded starch, xanthan, polyacrylates, polyetherpolyols or polyurethane derivatives, partially hydrolysed polymers of vinyl acetate, preferably polyvinyl alcohol, which are hydrolysed to the extent of more than 70%, and/or vinyl alcohol copolymers, preferably copolymers of vinyl acetate and alkylvinyl ester, which are partly or fully saponified, and also polyvinyl alcohol itself, polymers of N-vinylpyrrolidone, or copolymers with vinyl esters.

Certain suitable thixotropic agents may also be included within these paint formulations as well. These would include, without limitation, phyllosilicates, pyrogenic silicas, and organic compounds based, for example, on high molecular mass polyolefins, hydrogenated castor oil, polyamides, polyacrylates. Also suitable are low molecular mass, gemicrystalline organic compounds based on urea and also acrylate copolymer microparticles, which form microgels in the desired paint and coating materials.

Suitable defoamers and foam preventatives may also be added, such as, again, without limitation, products include those based on natural oils or mineral oils, optionally chemically modified alcohols and chemically modified silicones and silica materials.

Besides the abovementioned additives, the paint formulations may include other standard paint additives and adjuvants, such as water-softeners, as pH regulators, further film-forming and levelling assistants, dryers (siccatives), anti-skinning agents, anti-fouling agents, UV protectants and stabilizers, biocides, wood preservatives, and the like.

The latex component may be any standard type and may include other binder materials. Suitable binders include both organic and inorganic compounds. In accordance with the invention there is no restriction as regards these compounds. Preferred organic binders are water-soluble, water-dispersible or water-emulsifiable, natural, natural-modified or synthetic, generally film-forming compounds. Synthetic binders are, for example, polymers based on acrylic, vinyl, styrene or isocyanate monomers and also mixtures and copolymers thereof. As natural-modified binders, mention may be made in particular of cellulose derivatives.

Natural binders that may be mentioned include natural resins, such as rosin or schellac, natural oils, especially oils containing fatty acids which are saturated or contain various degrees of unsaturation, said oils being oxidatively drying if desired, such as linseed oil, ricinene oil, soya oil, castor oil, and the like, bitumen, asphalt or pitch.

Naturally modified binders are, in particular, chemically modified natural resins, e.g. rosin-maleate resin, and also modified oils, e.g. thick oils, isomerized oils, styrenized and acrylated oils, cyclo oils, and also maleate oils, urethane oils and factorized oils. Further natural-modified binders are cellulose derivatives such as cellulose nitrates, cellulose esters of organic acids, and also modified natural rubber such as cyclo rubber and chlorinated rubber, for example.

Examples of synthetic binders are saturated polyesters obtained by polyesterifying bifunctional or higher polyfunctional alcohols with polyfunctional saturated-aliphatic, cyclo-aliphatic or aromatic carboxylic acids and/or their anhydrides; both hydroxy-functional and carboxy-functional polyesters are suitable.

Furthermore, mention may be made of unsaturated polyesters, free-radically copolymerized if desired with monomeric methacrylates, allyl compounds, other unsaturated monomers, especially styrene, and also of unsaturated radiation-curing acrylate resins such as polyester, polyether, epoxy and urethane acrylates, for example.

Further synthetic organic binders are alkyd resins (polyesters modified with fatty acids, fatty oils or higher synthetic carboxylic acids) and also chemically modified alkyd resins, examples being styrenized, acrylated, urethanized, silicone-modified, polyamide-modified and resin-modified alkyd resins, and also especially water-dilutible alkyd resins, based for example on neutralizable short-oil and medium-oil, carboxyacidic alkyd resins, self-emulsifiable alkyl resins of reduced acid number, having permanently hydrophilic polyether chains in the molecule, and also alkyd resins which can be emulsified by means of surfactants.

Further suitable organic binders include acrylic resins (polyacrylates) in the form of their homopolymers and copolymers, e.g. styrene acrylate, and also polyacrylic polyols. Water-dilutible acrylic resins are particularly preferred.

Solvents may also be present within these paint formulations. Preferred solvents include water-soluble or water-miscible solvents. The solvent may serve either as a cosolvent for the latex and/or binder component or as an auxiliary for improving the drying and film-forming properties of the paint and coating materials. Also suitable are mixtures of different solvents, and, where appropriate, also polymeric, high-boiling solvents having a boiling point of more than 250° C. In accordance with the invention there is no restriction as regards the solvents to be used. Preference, however, is given to those used in the prior art paint and coating materials. These include, in particular, compounds from the group of the aliphatic, cycloaliphatic or aromatic hydrocarbons and terpene hydrocarbons, and also alcohols, glycol ethers and polyglycol ethers, esters and ketones. Amine-type solvents are also suitable, especially those based on primary, secondary and tertiary, aliphatic and also aromatic or cycloaliphatic amines, and also mixtures and derivatives thereof.

The amount of solvent introduced where appropriate in the system of the invention is guided by the desired processing properties and by the use of the paint and coating materials and also by environmental aspects of the application. In general, solvents should be compatible with the coating material and volatile on application under the particular film formation conditions. The above mentioned solvents may also function as diluents or extenders for the paint and coating material. Based on the said system, the solvent content is preferably less than 55% by weight, in particular less than 30% by weight.

Typically, latex paint contains by weight of total composition, from about 10 to 50% of a latex, from about 10 to 50% of an opacifying pigment (e.g. TiO₂, clay, calcium carbonate, silica, etc.) and from about 0.1 to 2% of dispersants/surfactants (e.g. polyacrylates, potassium tripolyphosphate, 2-amine-2-methyl-1-propanol, etc). Additionally, the paint formulation may also include from 4.9 to 98.9% by weight, in particular from 10 to 80% by weight, of water and, where appropriate, a water-soluble or water-miscible solvent. The viscosifying effect of the present invention depends on the molecular weight of the cellulose ether and the amount added to the paint. Typically, the amount of cellulose ether/gellan gum combination will be in the range of 0.05% to 5%, preferably from 0.1% to 1.0%, based on the weight of total composition.

In general, though, the paint and coating material system of the invention preferably contains any standard amount of solvent(s) and solid(s), as paint formulations may differ significantly in terms of these components and their proportions therein (i.e., gloss and semi-gloss types). The importance issue is the selection of a proper cellulose ether/network building polymer thickener system in the ratios noted previously. With that being said, the wide ranges of potential proportions of paint components are reflected as follows: from 1 to 95% by weight, in particular from 5 to 70% by weight, of at least one solid pigment and from 0.1 to 60% by weight, in particular from 1 to 30% by weight, of the binder/latex component, and from 0.1 to 5% by weight of the inventive thickening system. Additionally, the paint formulation may also include from 4.9 to 98.9% by weight, in particular from 10 to 80% by weight, of water and, where appropriate, a water-soluble or water-miscible solvent. These are merely guidelines to follow, however, as, again, many different formulations may be possible. The PVC amounts are included within these large ranges.

### PREFERRED EMBODIMENTS OF THE INVENTION

Certain embodiments of the inventive paint formulations were prepared in accordance with the following non-limiting examples.

### Preparation of Viscous Fluid Gels

Three different methods were followed to prepare the thickening system fluid gels, as follows:

Method A. Hot Mix (with Low Acyl-Gellan Gum or High Acyl-Gellan Gum)

A Finnfix 2000:KELCOGEL® CG-LA or FINNFIX® 2000:KELCOGEL LT100—HA powders were dry-blended and added with mixing to deionized water at ambient temperature, (˜25° C.). The contents were heated to 90° C. and held for 5 minutes with mixing. To the mixture were added 5 mM Ca++ (as CaCl₂) or 1% NaCl and then cooled to ˜25° C. without mixing, at which point moderate mixing was resumed to form a weak gel, biocide was added and the fluid gel was placed in a container to be added to a paint at any point of the manufacturing process, e.g. following pigment dispersion or after addition of the latex binder.

Method B. Cold Mix (In Situ) at Beginning of the Pigment Grind (with Low-Acyl Gellan Gum)

To a standard paint process container was added sufficient tap water to disperse titanium pigment and then an amount of sodium citrate equal to 0.20 wt % (based on weight of water) was dry-blended with Kelcogel CG-LA powder and added to the water with mixing. A cellulose gum, e.g. Finnfix 2000 (CMC) was slurried in propylene glycol and then added to the water so that the total gum combination was 0.4-0.53 wt % (based on the total paint weight) and the ratio of CMC:Gellan gum was between 8:1 and 10:1. The gum blend was mixed for 30 minutes on a high-speed disperser, e.g. Cowles Dissolver. Other liquid ingredients and pigments were then added and dispersed. When the pigment dispersion was complete, 10 mM Ca++ (as CaCl₂) were added with mixing to produce a fluid gel prior to adding the latex and remaining ingredients. The gelling salt can also be added at the completion of the paint manufacturing process.

Method C. Hot Mix: Post Addition (with High-Acyl Gellan Gum Solution

A separate solution of 0.50 weight % Kelcogel HA (high acyl gellan gum) was heated in deionized water to 90° C. and held for 5 minutes with mixing and cooled without mixing to form a fluid gel. A biocide was added to the cooled solution. The 0.50 weight % gellan gum solution was added to the paint after latex addition with mixing. An amount of CMC (Finnfix 2000) was added as a slurry in propylene glycol during the pigment grind phase of the paint process so that the final combined gum concentration was 0.50 weight % (based on total paint weight) and the CMC:gellan gum ratio was 8:1.

The following examples further illustrate the merits of this invention in terms of paint formulations produced therewith the systems prepared within the methods listed above. The applied cellulosics did have the following specifications:

| | | Natrosol 250 |
|---|---|---|
| Analysis | FF-2000 | HBR |
| Moisture (%) | 6., 7 | 2., 9 |
| Viscosity pH adj (mPas) | 2% 2600 | 1% 1460 |
| pH | 6., 9 | 7, .4 |
| DS | 8., 88 | — |
| NaCl (%) | 0., 8 | 0, .2 |

### Example 1

Paints were prepared according to preparation method B to evaluate the suspension of the pigments in an Acrylic semi-gloss latex paint (25% PVC) at pH around 8.3. A comparison was made between a single gum CMC-containing system and a system stabilized with a blend of cellulose gum and LA-gellan gum. The paint was mixed with the appropriate amount of thickener to end-up with the Stormer viscosity of the paint of 77+/−1 KU.

| | | |
|---|---|---|
| Water | 344.90 | grams |
| Sodium citrate | 0.70 | |
| Kelcogel CG-LA | 0.60 | |
| Finnfix 2000 | 4.40 | |
| Propylene glycol | 18.90 | |
| Tamol 731 | 8.60 | |
| Triton N-57 | 2.00 | |
| Surfynol DF-75 | 0.90 | |
| Ti02 | 226.30 | |
| Polygloss 90 | 18.80 | |
| 0.4 M Ca++ | 7.90 | |

Disperse on high-speed disperser

| | | |
|---|---|---|
| Acrylic latex | 353.30 | |
| AMP-95 | 0.90 | |
| Kathon LX | 2.40 | |
| Triton GR-7M | 0.50 | |
| Texanol | 8.90 | |
| Total weight | 1000.00 | grams |

PVC = 25%
Solids by weight 45.6%
Solids by volume 31.8%
Gum combination (by wt) 0.50%
Ratio CMC:Gellan gum 8:1

### Example 2

Paints were prepared according to preparation method B to evaluate the suspension of the pigments in a Flat latex paint (63% PVC) at pH around 8.5. A comparison was made between a single gum cmc containing system and a system stabilized with a blend of cellulose gum and LA-gellan gum. In addition, a comparison had been made to a reference that also contained associative thickener. To the systems containing the gellan, salt was added as gelling agent and the time of addition was varied for reason of comparison. The paint was prepared with 0.5 wt % thickener.

| Component | Amount | |
|---|---|---|
| Water | 279.0 | grams |
| Sodium citrate | 0.60 | |
| Kelcogel CG-LA | 0.60 | |
| Finnfix 2000 | 3.18 | |
| Propylene glycol | 16.80 | |
| Surfynol DF-75 | 2.50 | |
| Tergitol NP-9 | 1.80 | |
| Tamol 850 | 5.90 | |
| Ti02 | 125.60 | |
| CaCO3 | 181.40 | |
| Clay | 125.10 | |
| Water | 51.00 | |
| 0.4 M Ca++ | 7.00 | |
| Surfynol DF-75 | 1.60 | |
| Vinyl-acrylic latex | 182.90 | |
| Proxel GXL | 0.90 | |
| AMP-95 | 1.30 | |
| Texanol | 11.60 | |
| Total weight | 1000.00 | grams |

PVC = 63%
Solids by weight = 55%
Solids by volume = 35%
Gum combination (by wt) 0.50%
Ratio CMC:gellan gum 8:1

| Component | Amount | |
|---|---|---|
| Water | 279.00 | grams |
| Sodium citrate | 0.60 | |
| Kelcogel CG-LA | 0.60 | |
| Finnfix 2000 | 4.00 | |
| Propylene glycol | 16.80 | |
| Surfynol DF-75 | 2.50 | |
| Tergitol NP-9 | 1.80 | |
| Tamol 850 | 5.90 | |
| Ti02 | 125.60 | |
| CaCO3 | 181.40 | |
| Clay | 125.10 | |
| Water | 51.00 | |
| 0.4 M Ca++ | 7.00 | |
| Surfynol DF-75 | 1.60 | |
| Vinyl-acrylic latex | 182.90 | |
| Proxel GXL | 0.90 | |
| AMP-95 | 1.30 | |
| Texanol | 11.60 | |
| Polyphobe TR-117 | 2.50 | |
| Total weight | 1002.50 | grams |

PVC = 63%
Solids by weight = 55%
Solids by volume = 35%
Gum combination (by wt) 0.50%
Ratio CMC:gellan gum 8:1

### Example 3

Paints were prepared according to preparation method A, to evaluate the suspension of the pigments in 74% PVC latex paint at pH around 7.6. A comparison was made between a single gum cellulosic (CMC or HEC) containing system and a system stabilized with a blend of cellulosic (cellulose gum or HEC) and LA-gellan gum. The paint was mixed with the appropriate amount of thickener to end-up with the Stormer viscosity of the paint of 93+/−1 KU. In the gum solution preparation 0.06% CaCl₂×2H₂0 was applied.

| Name | Amount (g) | |
|---|---|---|
| Water + thickener | 363 | |
| Dispex N 40 | 3 | |
| Nopco 8034 | 3 | |
| Acticide BX | 2 | |
| Kronos 2065 | 60 | |
| Omyacarb 2-GU | 400 | |
| Kaolin speswhite | 40 | |
| Mowilith FE 174S | 127 | |
| Nopco 8034 | 2 | |
| Total | 1000 | g |

### Example 4

Paints were prepared according to preparation method A, to evaluate the suspension of the pigments in 74% PVC latex paint at pH around 7.6. The composition was varied to determine how the nature of the gellan (low acyl versus high acyl) affects the paint performance (at three different gum levels and/or ratios). In the gum solution preparation 1% NaCl was applied.

| Name | Amount (g) | |
|---|---|---|
| Water + thickener | 363 | |
| Dispex N 40 | 3 | |
| Nopco 8034 | 3 | |
| Acticide BX | 2 | |
| Kronos 2065 | 60 | |
| Omyacarb 2-GU | 400 | |
| Kaolin speswhite | 40 | |
| Mowilith FE 174S | 127 | |
| Nopco 8034 | 2 | |
| Total | 1000 | g |

### Example 5

Paints were prepared according to preparation method C, to evaluate the suspension of the pigments in an acrylic semi-gloss latex paint (25% PVC) at pH around 7.8. A comparison was made between a single gum CMC-containing system and a system stabilized with a blend of cellulose gum and HA-gellan gum. The paints were mixed with 0.50 wt % thickener.

| Component | Amount | |
|---|---|---|
| Water | 242.5 | grams |
| Finnfix 2000 | 27.8 | |
| Propylene glycol | 18.9 | |
| Tamol 731 | 8.7 | |
| Triton N-57 | 2.0 | |
| Surfynol DF 75 | 0.9 | |
| Titanium dioxide | 226.7 | |
| Polygloss 90 | 18.8 | |
| Acrylic latex | 354.0 | |
| AMP-95 | 1.0 | |
| Kathon LX | 2.4 | |
| Triton GR-7M | 0.5 | |
| Texanol | 8.9 | |
| Kelcogel HA (0.50%) | 110.3 | |
| Total | 1000.0 | grams |

PVC = 25%
Solids by weight = 5.6
Solids by volume = 31.8
Gum combination by wt = 0.50%
Ratio CMC:Gellan = 8:1

### Testing of Paint Formulations

These paint formulations were then analyzed for a number of different properties. The methods below were applied for these purposes.

Leveling of Paint, ASTM D-4062

This test method evaluates the ability of paint to flow out after application and thus obliterate any surface irregularities like a brush marks, orange peel, peaks or craters, which have been produced by the mechanical process of application. To simulate the shear created by brush application, paint sample is pre-sheared by ejecting the sample trough a syringe and needle. Paint sample is applied on a sealed chart by special leveling test blade designed to lay down a film with parallel ridges simulating brush marks. After drying for 24 hours at constant conditions (23±2° C. and 50±5% relative humidity) in a horizontal position, levelling of the test paint is rated by viewing the draw-down under a strong oblique light source, comparing the contrast of lightness and shadow caused by the paint ridges to that of a series of plastic levelling standards under the same lightning conditions. Leveling is rated from 0 to 10, where 0 presents very poor levelling and 10 presents perfect leveling or no perceptible ridges.

Sag Resistance of Paint, ASTM D4400

This test method evaluates the sag resistance of paint, the tendency of a wet paint to flow downward when applied to a vertical surface. A pre-shear is essential for a drawdown sag test to make sure the breakdown in structure, which occurs in thixotropic paints. The paint sample is pre-sheared by ejecting the sample trough a syringe and needle. After pre-shearing, the coating is applied to a test chart by a multinotch applicator, which has 10 increasingly deep rectangular notches. Notch clearances range from 100 μm to 600 μm (4 to 24 mils). The charts are immediately hung vertically with the drawdown stripes horizontal with the thinnest stripe at the top. After drying in this position, the drawdown is examined and sagging is rated for the thickest stripe which does not overlap the stripe of bare test panel just below.

Spatter Resistance of Paint, ASTM D4707

This test method determines the tendency of paint to spatter when applied with a roller. The test paint is applied to a black plastic panel by a special drawdown applicator. The coated plastic panel is immediately mounted on a vertical surface above a sheet of black paper (if paint is white) used to catch any spatter making ten passes in each direction (20 passes totally). A specially designed notched spool roller is rolled through the film tending to generate spatter. Any spatter, which falls upon the spatter catch paper and after drying, is rated against the pictorial standards. Spatter resistance is rated on a scale of 1 to 10, where 1 represents hundreds of drops of spatter and 10 represents no spatter. Rating depends on number rather tan size, of drops.

Paint Viscosity by a Stormer Viscometer, ASTM D562

This test method measures viscosity of paint with low shear rates, 200 rpm, which corresponds to the shear rate of paint in the can. Viscosity is measured with a Stormer viscometer at 25° C., where torque of a spindle rotating at 200 rpm is converted to viscosity in Krebs Units (KU).

Paint Viscosity by an ICI Cone & Plate Viscometer, ASTM D4287

This test method measures viscosity of paint with high shear rates, 10 000 s-1, which corresponds to the shear rate when paint is applied by a roller. Viscosity is measured with an ICI Cone & Plate viscometer at 25° C., where sample is placed between the rotating cone and stationary plate. Viscosity result is given as Poises (P) or centipoises (cP).

Paint viscosity by a Brookfield LVTDV-II Viscometer, ASTM D 1439-83a

Viscosity is measured with a Brookfield LVTDV-II viscometer at 25° C., where torque of a spindle is converted to viscosity in Milli-Pascal seconds (mPas).

Stability Test of Paint, “Settling” Test

The test determines the paint stability during the storage at room temperature (r.t.) and 50° C. Settling evaluation of solid matter in paints is made visually from transparent closed glass containers which were stored at r.t and 50° C. Paints are divided into two parts were the other part is stored at r.t and the other part at 50° C. Paints were stored for specified periods, e.g. 1, 2, 3 months, etc.

Paint Viscosity Measured by a Programmable Brookfield LVTDV-III Viscometer

The waterborne paint is stored in a transparent plastic container approximately 5.5 cm in diameter and 9 cm in height with a screw-type lid. The container holds approximately 200 grams of the waterborne paint. The Brookfield viscosity of the paint is measured in this container so that the diameter is consistent and viscosity values are easily compared. The cylindrical Brookfield spindles are used to measure the viscosity (between 5 and 95% torque). The viscosity program is as follows:

| Viscometer speed | Hold time |
|---|---|
| 60 RPM | 1 minute, then take reading |
| 30 RPM | 1 minute, then take reading |
| 3 RPM | 2 minutes, then take reading |
| 0.3 RPM | 5 minutes, then take reading. |

Note:
Proceeding from high to low shear rate avoids any thixotropy that may be present and that would generate inconsistent data.

The results of the testing are provided below in the following tables for each of the Examples 1-5.

### Example 1

### Results

CMC/Gellan Gum in Semi-Gloss Latex Paints

| | | Control |
|---|---|---|
| CMC:Gellan Gum | 8 to 1 | 100 to 0 |
| Wt % LA-Gellan Gum | 0.055 | 0.000 |
| Wt % FF2000 | 0.438 | 0.493 |
| Std Tap Water (used to | Yes | Yes |
| make paint) | | |
| PVC, % | 24.80 | 24.80 |
| Volume Solids, % | 31.80 | 31.80 |
| Weight Solids, % | 45.60 | 45.60 |
| Results: | | |
| Brookfield Viscosity (RV) | | |
| (cP) | | |
| 60 RPM | 1621 | 1451 |
| 0.3 RPM | 80000 | 67000 |
| Stormer Viscosity (KU) | 77 | 77 |
| ICI Viscosity (P) | 0.40 | 0.50 |
| Leneta Flow/Leveling | 7.00 | 6.00 |
| (10 = best) | | |
| Sag Rating, mils | 20.00 | 16.00 |
| (24 mils = best, 4 mils = | | |
| worst) | | |
| pH | 8.44 | 8.20 |
| Package Stability | | |
| 25 C., 8 weeks | Good¹ | Good¹ |
| 50 C., 7 weeks | Fair- | Fair- |
| | good² | good² |

Note:
¹no syneresis
²Some syneresis

The results clearly show that in presence of CMC-gellan this paint formulation gives a higher viscosity at low shear rates (0.3 rpm BE) and a higher sag rating and better leveling while maintaining acceptable and similar values for high shear viscosity and stability as compared to the paint with only CMC.

### Example 2

### Results

CMC/Gellan Gum in Flat Latex Paints

| | | | Control | |
|---|---|---|---|---|
| CMC to Gellan Gum | 8 to 1 | 8 to 1 | 100 to 0 | 100 to 0 |
| Wt % LA Gellan Gum | 0.055 | 0.055 | 0 | 0 |
| Wt % FF2000 | 0.444 | 0.444 | 0.50 | 0.50 |
| Tap Water | Yes | Yes | Yes | Yes |
| PVC, % | 63 | 63 | 63 | 63 |
| Volume Solids, % | 35 | 35 | 35 | 35 |
| Weight Solids, % | 55 | 55 | 55 | 55 |
| Results: | | | | |
| Brookfield Viscosity | | | | |
| (cP), RV | | | | |
| 60 RPM | 1584 | 1611 | 1792 | 2048 |
| 0.3 RPM | 68267 | 67200 | 57600 | 59733 |
| Stormer Viscosity (KU) | 83 | 82 | 86 | 90 |
| ICI Viscosity (P) | 0.90 | 1.00 | 1.10 | 1.15 |
| Leneta Flow and | 8 | 8 | 8 | 6 |
| Leveling | | | | |
| (10 = best) | | | | |
| Sag Rating, mils | 8 | 8 | 8 | 16 |
| (24 mils = best, 4 mils = | | | | |
| worst) | | | | |
| pH | 8.27 | 8.66 | 8.65 | 8.59 |
| Ca⁺⁺ added (0.4M) | end of | prior to | N/A | N/A |
| | process | adding | | |
| | | binder | | |
| Polyphobe TR-117(wt % | 0.00 | 0.00 | 0.00 | 0.10 |
| solids) | | | | |
| {associative thickener} | | | | |
| Package Stability | | | | |
| 25 C., 7 weeks | Good¹ | Good¹ | Good¹ | Good¹ |
| 50 C. 12 weeks | Good¹ | 7.7² | 16.7² | 15.4² |

Note:
¹No syneresis
²% Syneresis

The paints from the present invention clearly show the higher viscosity at low shear rates (0.3 RPM BF) and similar leveling and sag score even though the Stormer viscosity is somewhat lower that the paint formulation with only CMC.

The paint system prepared by adding gelling salt to the fluid gel at the end of the paint manufacturing process resulted in higher low-shear viscosity (Brookfield 0.3 RPM) and greater package stability at elevated temperature versus adding the gelling salt during the paint process.

The addition of 0.10% solids of an hydrophobically modified alkali-swellable (HASE) type associative thickener resulted in improved sag control but did not significantly enhance the package stability versus a CMC control.

Note: Flow and leveling property was not impaired by the use of the fluid gel as a rheological agent versus a CMC control.

### Example 3

### Results

| | Concentration in | | | | | |
|---|---|---|---|---|---|---|
| | final paint | | | | | |
| | A (ref) | A (ref-2) | B | C | D (ref) | E |
| Thickener | | | | | | |
| FF2000 | 0.47 | 0.5 | 0.407 | 0.436 | | |
| HEC | — | — | | | 0.32 | 0.290 |
| Kelcogel CG-LA | — | — | 0.041 | 0.036 | | 0.029 |
| Ratio (cellulosic:GG) | 100:— | 100:— | 10:1 | 12:1 | 100:— | 10:1 |
| Properties | | | | | | |
| Stormer viscosity KU | 93 | 94 | 93 | 93 | 93 | 93 |
| ICI C&P visco (cP) | 115 | 110 | 105 | 110 | 100 | 100 |
| | | 115 | | 115 | | |
| BF visco (sp 4, 30 rpm) | 4050 | 3820 | 4600 | 4550 | 4480 | 4680 |
| mPas | | | | | | |
| BF visco (sp 4, 0.3 rpm) | 91980 | | 164000 | 156000 | 128000 | 174000 |
| Sagging test (mils) | 20 | 14 | 24 | 24 | 24 | 24 |
| (24 mils = best, 4 mils = | | 12 | | | | |
| worst) | | | | | | |
| Leveling test | 5 | 7 | 4 | 3 | 3 | 2 |
| (10 = best) | | 6 | | | | |
| Spattering test | 7 | 8 | 7 | 7 | 6 | 6 |
| (10 = best) | | | | 8 | | |

Sample A (Ref-2) is different from sample A (Ref) as no heating was applied and no salt has been added.

The CMC-gellan formulations show a strong increase in low shear-rate viscosity (0.3 RPM BF), an improved sag rating at acceptable. The HEC-gellan also shows a clear increase in low shear-rate viscosity while maintaining the other basic paint performance.

### Example 4

### Results

| | A | B | C | D | E | F |
|---|---|---|---|---|---|---|
| Thickener | | | | | | |
| FF2000 | 0.363 | 0.363 | 0.29 | 0.29 | 0.436 | 0.436 |
| Kelcogel CG-LA | | 0.0363 | | 0.073 | | 0.109 |
| kelcogel CG-HA | 0.0363 | | 0.073 | | 0.109 | |
| Ratio (cellulosic:GG) | 10:1 | 10:1 | 4:1 | 4:1 | 4:1 | 4:1 |
| Properties | | | | | | |
| Stormer viscosity KU | 89 | 84 | 87 | 81 | 105 | 95 |
| ICI C&P visco (cP) | 90 | 85 | 80 | 70 | 120 | 115 |
| | | | 75 | | | |
| BF visco (sp 4, 30 rpm) mPas | 3500 | 2880 | 4240 | 2800 | 7500 | 5140 |
| Sagging test (mils) | 16 | 16 | 18 | 16 | 24 | 24 |
| (24 mils = best, 4 mils = | | | | | | |
| worst) | | | | | | |
| Leveling test | 6 | 5 | 5 | 5 | 4 | 3 |
| (10 = best) | 7 | 6 | | 6 | 3 | 4 |
| Spattering test | 7 | 7 | 8 | 8 | 8 | 8 |
| (10 = best) | | | | | | |

The High Acyl gellan gum shows a higher low shear-rate viscosity as compared to the low acyl samples for each investigated overall gum level. The other paint properties were all rather similar amongst the two gellan types.

### Example 5

### Results

| | Thickener | |
|---|---|---|
| | 8:1 FF2000:HA | 100% FF2000 |
| | Gellan Gum | (control) |
| Wt % Kelcogel HA | 0.055 | 0.000 |
| Wt % Finnfix 2000 | 0.438 | 0.493 |
| Brkfld Viscosity, 60 RPM, cP | 2048 | 1451 |
| Brkfld Viscosity, 0.3 RPM, cP | 123., 000 | 67., 000 |
| Stormer Viscosity, KU | 77 | 87 |
| ICI Viscosity, Poise | 0.50 | 0.50 |
| Leneta Flow/Leveling Test | 6.5 | 6.0 |
| (10 = best) | | |
| Sag Test (mils) | 18 | 16 |
| (18 = best) | | |
| StabilityTest, 50° C., 7 weeks | 0% syneresis | 6.7% syneresis |
| pH | 7.68 | 7.96 |

The HA-gellan gum shows much higher medium shear (60 RPM) as well as significantly higher low-shear (0.30 RPM) viscosity than the control cellulose gum thickener. The low shear viscosity clearly relates to the long-term, elevated temperature stability of the gellan gum, especially the high acyl gellan gum, and the cellulosic combination. In addition, the flow and leveling property did not appear to be adversely affected by the higher viscosity of the HA-gellan gum.

It is thus evident that in each of these formulations that acceptable levels of each property has been met. Such across-the-board results are highly desirable and heretofore unattained by other typical thickening systems within the paint industry.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

1.-18. (canceled)

19. A thickening system comprising at least one cellulose ether and at least one network building polymer, wherein the weight ratio of the at least one cellulose ether to the at least one network building polymer is from 4:1 to about 40:1, respectively.

20. The thickening system of claim 19 wherein the weight ratio of the at least one cellulose ether to the at least one network building polymer is from 4:1 to about 20:1.

21. The thickening system of claim 19 wherein:
the at least one cellulose ether is selected from the group consisting of carboxymethyl cellulose (CMC), hydroxylethyl cellulose (HEC), ethyl hydroxylethyl cellulose (EHEC), methyl cellulose (MC), methyl hydroxylethyl cellulose (MHEC), hydroxypropylmethyl cellulose (HPMC) ethers, and any mixtures thereof; and
the at least one network building polymer is selected from the group consisting of gellan gum, carrageenan, pectin, alginate, agar, gelatin, and blends thereof.

22. The thickening system of claim 19 wherein the at least one cellulose ether is CMC and the at least one network building polymer is gellan gum.

23. The thickening system of claim 22 wherein the gellan gum is low acyl gellan gum.

24. The thickening system of claim 22 wherein the gellan gum is high acyl gellan gum.

25. The thickening system of claim 22 wherein the weight ratio of the at least one cellulose ether to the at least one network building polymer is from 4:1 to about 20:1.

26. The thickening system of claim 22 wherein the CMC has a molecular weight from about 30,000 to 1,000,000 Daltons.

27. The thickening system of claim 22 wherein the CMC has a degree of substitution between 0.5 and 1.5.

28. The thickening system of claim 22 wherein the gellan gum has a molecular weight from about 400,000 to 700,000 Daltons.

29. A thickening system consisting essentially of at least one cellulose ether and at least one network building polymer, wherein the weight ratio of the at least one cellulose ether to the at least one network building polymer is from 4:1 to about 40:1, respectively.

30. The thickening system of claim 29 wherein the weight ratio of the at least one cellulose ether to the at least one network building polymer is from 4:1 to about 20:1.

31. The thickening system of claim 29 wherein:
the at least one cellulose ether is selected from the group consisting of carboxymethyl cellulose (CMC), hydroxylethyl cellulose (HEC), ethyl hydroxylethyl cellulose (EHEC), methyl cellulose (MC), methyl hydroxylethyl cellulose (MHEC), hydroxypropylmethyl cellulose (HPMC) ethers, and any mixtures thereof; and
the at least one network building polymer is selected from the group consisting of gellan gum, carrageenan, pectin, alginate, agar, gelatin, and blends thereof.

32. The thickening system of claim 29 wherein the at least one cellulose ether is CMC and the at least one network building polymer is gellan gum.

33. The thickening system of claim 32 wherein the weight ratio of the at least one cellulose ether to the at least one network building polymer is from 4:1 to about 20:1.

34. A method for thickening a composition comprising combining the composition with an effective amount of a thickening system comprising at least one cellulose ether and at least one network building polymer, wherein the weight ratio of the at least one cellulose ether to the at least one network building polymer is from 4:1 to about 40:1, respectively.

35. The method of claim 34 wherein the weight ratio of the at least one cellulose ether to the at least one network building polymer is from 4:1 to about 20:1.

36. The method of claim 34 wherein:
the at least one cellulose ether is selected from the group consisting of carboxymethyl cellulose (CMC), hydroxylethyl cellulose (HEC), ethyl hydroxylethyl cellulose (EHEC), methyl cellulose (MC), methyl hydroxylethyl cellulose (MHEC), hydroxypropylmethyl cellulose (HPMC) ethers, and any mixtures thereof; and
the at least one network building polymer is selected from the group consisting of gellan gum, carrageenan, pectin, alginate, agar, gelatin, and blends thereof.

37. The method of claim 34 wherein the at least one cellulose ether is CMC and the at least one network building polymer is gellan gum.

38. The method of claim 37 wherein the weight ratio of the at least one cellulose ether to the at least one network building polymer is from 4:1 to about 20:1.

39. The method of claim 34 wherein the thickening system imparts a viscosity increase of at least 15% to the composition at 0.3 rpm as measured on a Brookfield viscometer.

40. The method of claim 34 wherein the thickening system imparts at least a level of syneresis to the composition after being subject to a package stability test at 25° C. for 7 weeks as that exhibited by a composition comprising the same components, except for the presence of the network building polymer.

41. The method of claim 34 wherein the thickening system is added to the composition in an amount from 0.1 to 5% by weight of the thickened composition.
